(19) United States
(12) Patent Application Publication
(10) Pub. No.: US 2007/0006248 A1
(43) Pub. Date: Jan. 4, 2007

(54) DISK DRIVE FOR PREVENTING TURNTABLE FROM TILTING

(75) Inventors: Qing-Li Chai, Jiangsu Province (CN); Ji-Wei Wang, Jiangsu Province (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/426,339

(22) Filed: Jun. 26, 2006

(30) Foreign Application Priority Data
Jul. 4, 2005 (TW) 94122612

(51) Int. Cl. G11B 19/20

(52) U.S. Cl. 720/701

(57) ABSTRACT

A disk drive for reading a disk is provided. The disk drive includes an optical pickup unit and a spindle motor. The optical pickup unit is disposed below the disk to read data of the disk. The spindle motor carries and drives the disk to rotate, so that the optical pickup unit is able to read the data from different areas of the disk. The spindle motor includes a motor portion and a turntable. The motor portion drives the turntable to rotate. The turntable is used for carrying a disk. The turntable includes a body and several slots. The slots are spread over the disk uniformly and symmetrically. Each of the slots is equipped with several anti-vibrating bodies. When the turntable rotates at high speed, the anti-vibrating bodies collide with one another to reduce the energy of tilting to prevent the turntable from tilting.

This application claims the benefit of Taiwan application Serial No. 94122612, filed Jul. 4, 2005, the subject matter of which is incorporated herein by reference.

### BACKGROUND OF THE INVENTION

1. Field of the Invention

The invention relates in general to a disk drive and a turntable thereof, and more particularly to a disk drive for preventing the turntable and the disk from tilting and a turntable thereof.

2. Description of the Related Art

The disk drive is used for receiving a disk and reading the data of the disk by an optical pickup unit. The optical pickup unit can read the data of the disk from different areas by a turntable disposed below the disk and rotated at high speed.

Referring to both FIG. 1A and FIG. 1B. In FIG. 1A, the turntable is rotating at low speed, and in FIG. 1B, the turntable is rotating at high speed. The turntable 101 is mounted on the spindle of the spindle motor, and there are gaps between the turntable 101 and the spindle during assembly. As shown in FIG. 1A, the turntable 101 does not tilt at a rotation speed below ω1, but starts to tilt obviously when the rotation speed is increased from ω1 to ω2. The farther away from the spindle, the faster the rotation will be. Therefore, a small gap would cause the outer end of the spindle to wobble, not only affecting read quality but also causing damage to the disk drive.

### SUMMARY OF THE INVENTION

It is therefore an object of the invention to provide a disk drive for preventing a turntable from tilting and the turntable thereof to enhance the read quality and prevent the disk drive from damage.

The invention achieves the above-identified object by providing a disk drive for reading a disk. The disk drive includes an optical pickup unit and a spindle motor. The optical pickup unit is disposed below the disk to read data of the disk. The spindle motor carries and drives the disk to rotate, so that the optical pickup unit is able to read the data from different areas of the disk. The spindle motor includes a motor portion and a turntable. The motor portion drives the turntable to rotate. The turntable is used for carrying a disk. The turntable includes a body and several slots. The slots are spread over the turntable uniformly and symmetrically. Each of the slots is equipped with several anti-vibrating bodies. When the turntable rotates at high speed, the anti-vibrating bodies collide with one another to reduce the energy of tilting to prevent the turntable from tilting.

The invention achieves the above-identified object by providing another spindle motor disposed in a disk drive. The spindle motor includes a motor portion and a turntable. The motor portion drives the turntable to rotate. The turntable used for carrying a disk includes a body and several slots. The slots are spread over the body of the turntable uniformly and symmetrically. Each of the slots is equipped with several anti-vibrating bodies. When the turntable rotates at high speed the anti-vibrating bodies collide with one another to reduce the energy of tilting to prevent the turntable from tilting.

Other objects features and advantages of the invention will become apparent from the following detailed description of the preferred but non-limiting embodiments. The following description is made with reference to the accompanying drawings.

### BRIEF DESCRIPTION OF THE DRAWINGS

FIG. 1A (Prior Art) is a schematic view showing that the turntable is rotating at low speed;

FIG. 1B (Prior Art) is a schematic view showing that the turntable is rotating at high speed;

FIG. 2 is a schematic view of the disk drive of the invention;

FIG. 3 is a top view of the turntable of the invention; and

FIG. 4 is a cross-sectional view along B-B direction of FIG. 3.

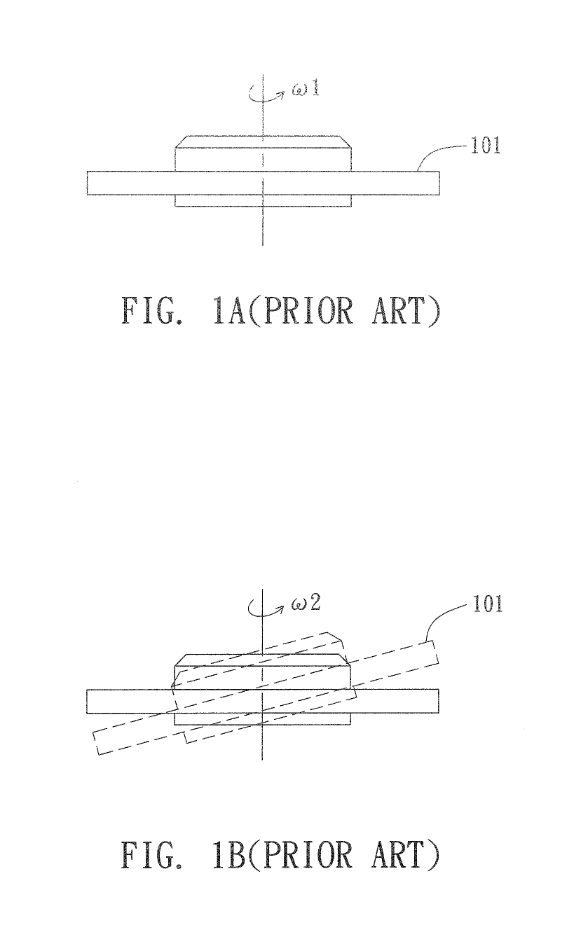

### DETAILED DESCRIPTION OF THE INVENTION

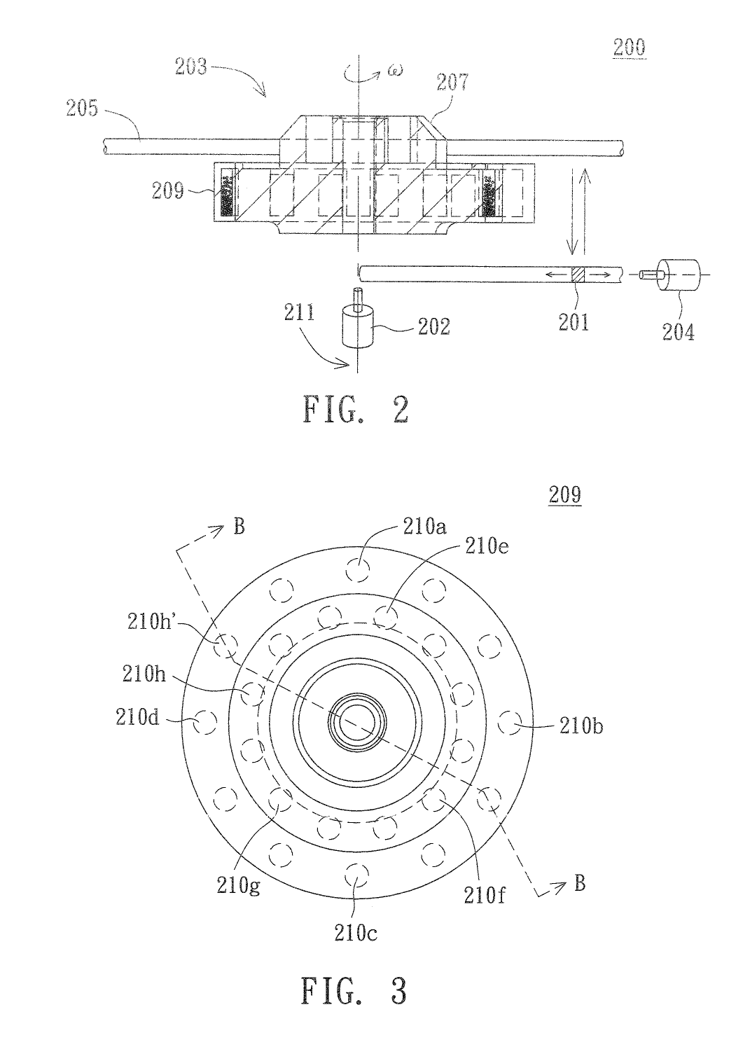

Referring to FIG. 2, a diagram of the disk drive is shown. The disk drive 200 includes an optical pickup unit 201 and a spindle motor 203. The spindle motor 203 includes a motor portion 202 and a turntable 209. The turntable 209 has a body 207 equipped with several slots. The motor portion 202 drives the turntable 209, so that the turntable 209 rotates around the spindle 211 of the spindle motor 203. The optical pickup unit 201 disposed below the spindle motor 203. The disk drive 200 further includes a horizontal motor 204 for driving the optical pickup unit 201 to move horizontally below the disk 205 to read data of the disk 205. When the disk 205 carried by the turntable 209 rotates along with the turntable 209, the disk 205 also rotates around the spindle 211.

Referring to FIG. 3, a top view of the turntable is shown. The turntable 209 is circular-shaped. The turntable 209 has several slots. The slots 210a, 210b, 210c and 210d are disposed in the outer end of the turntable 209, and the slots 210e, 210f, 210g and 210h are disposed in the inner end of the turntable 209. In the outer end of the turntable 209, the slot 210a corresponds to the slot 210c, and the slot 210b corresponds to the slot 210d. In the inner end of the turntable 209, the slot 210e corresponds to the slot 210g, and the slot 210f corresponds to the slot 210h. Each slot has several anti-vibrating bodies sealed in it. The anti-vibrating bodies are small-sized and spherical-shaped, and include high-density metal. The anti-vibrating bodies are preferably balls including tungsten alloy. For example, if the slot 210a has 30 small-sized anti-vibrating bodies, then the corresponding slot 210c and other slots positioned in the outer end of the turntable 209 also need to have the same number of anti-vibrating bodies of the same type so that the slots in the outer end of the turntable 209 have the same weight. Similarly, if the slot 210e has 40 anti-vibrating bodies, then each slot in the inner end of the turntable 209 needs to have the same number of anti-vibrating bodies to maintain the balance of the inner end of the turntable 209. The slots can be disposed in the outer end of the turntable 209 or the inner end of the turntable 209 only as long as each slot in the same end of the turntable 209 (the outer end of the turntable 209 or the inner end of the turntable 209) has the same weight of anti-vibrating bodies. It is important to ascertain that the slots and the anti-vibrating bodies are symmetrically disposed with respect to the spindle 211 of the turntable 209, lest the turntable might tilt during rotation.

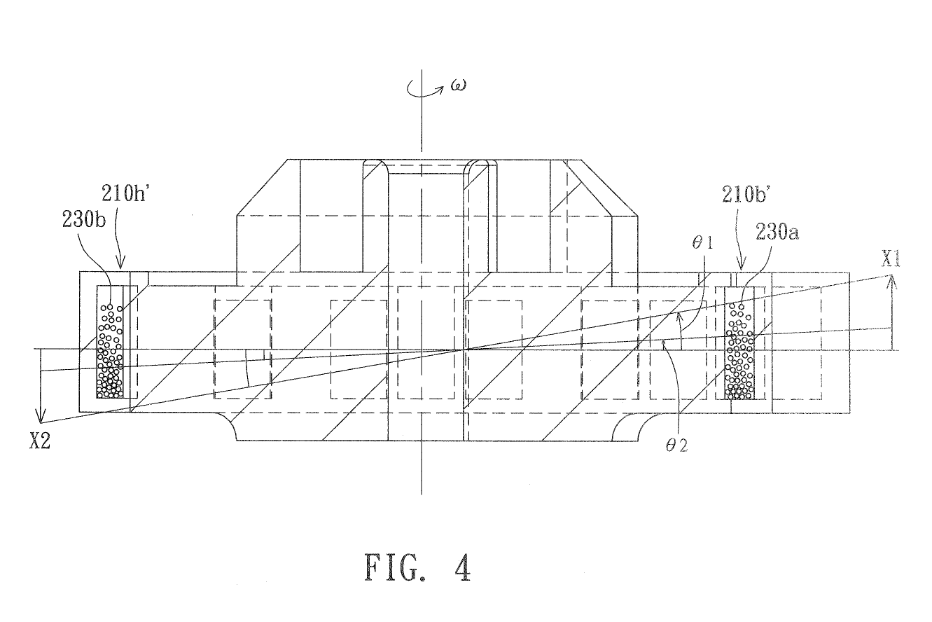

Referring to FIG. 4, a cross-sectional view along B-B′ direction of FIG. 3 is shown. It can be seen from the direction of the cross-sectional line B-B′ that the slots 210b′ and 210h′ respectively have several anti-vibrating bodies such as anti-vibrating bodies 230a and 230b for instance. When the turntable 209 rotates at low speed, the turntable 209 would not wobble. However, when the turntable 209 rotates at high speed, the turntable 209 would start to wobble. If the slot 210b′ positioned at the right-hand side of the spindle 211 tilts upwardly along the X1 direction, the slots 210h positioned at the left-hand side of the spindle 211 would tilt downwardly along the X2 direction. According to the law of inertia, the anti-vibrating bodies disposed inside the slots 210b′ would move upwardly along the X1 direction together, and the anti-vibrating bodies disposed inside the slots 210h′ would move downwardly along the X2 direction together. During the course of upward movement, the anti-vibrating bodies disposed inside the slots 210b′ would collide with one another, resulting in the loss of the upward energy of the anti-vibrating bodies. Similarly, during the course of downward movement, the anti-vibrating bodies disposed inside the slots 210h′ would collide with one another, resulting in the loss of the downward energy of the anti-vibrating bodies. Consequently, the tilting angle is reduced from θ1 to θ2, so that the wobbling is mitigated. Therefore, the higher density the anti-vibrating bodies posses, the larger the energy of tilting will be reduced. The smaller-sized the anti-vibrating bodies are, the larger contact area the anti-vibrating bodies will collide with one another. The larger the contact area is, the higher the number of collisions will be.

The disk drive and the spindle motor thereof disclosed in the aforementioned embodiment of the invention reduces the energy of tilting within the turntable by several small-sized anti-vibrating bodies, which are disposed in the slots of the turntable of the spindle motor and collide with one another to reduce vibration of the turntable. By doing so, the optical pickup unit is able to read the data with higher accuracy and is prevented from causing errors to other components of the disk drive due to vibration, so that the operation efficiency and quality of the disk drive and the spindle motor are enhanced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A spindle motor disposed in a disk drive, comprising:
a motor portion; and
a turntable driven to rotate by the motor portion for carrying a disk, wherein the turntable comprises:
a body; and
a plurality of slots uniformly and symmetrically spread over the body, wherein each of the slots is equipped with a plurality of anti-vibrating bodies, and when the turntable rotates at high speed, the anti-vibrating bodies collide with one another to reduce the energy of the turntable to prevent the turntable from tilting.

2. The spindle motor according to claim 1, wherein each of the slots is cylinder-shaped.

3. The spindle motor according to claim 1, wherein each of the anti-vibrating bodies is spherical-shaped.

4. The spindle motor according to claim 1, wherein each of the anti-vibrating bodies includes metal.

5. The spindle motor according to claim 4, wherein each of the anti-vibrating bodies includes high-density metal.

6. The spindle motor according to claim 5, wherein each of the anti-vibrating bodies includes tungsten alloy.

7. A disk drive for reading a disk, comprising:
an optical pickup unit disposed below the disk for reading data of the disk; and
a spindle motor, which carries and drives the disk to rotate, so that the optical pickup unit is able to read the data from different areas of the disk, wherein the spindle motor comprises:
a motor portion; and
a turntable driven to rotate by the motor portion for carrying the disk, and the turntable comprises:
a body; and
a plurality of slots uniformly and symmetrically spread over the body, wherein each of the slots is equipped with a plurality of anti-vibrating bodies, and when the turntable rotates at high speed, the anti-vibrating bodies collide with one another to reduce the energy of the turntable to prevent the turntable from tilting.

8. The disk drive according to claim 7, wherein each of the slots is cylinder-shaped.

9. The disk drive according to claim 7, wherein each of the anti-vibrating bodies is spherical-shaped.

10. The disk drive according to claim 7, wherein each of the anti-vibrating bodies includes metal.

11. The disk drive according to claim 10, wherein each of the anti-vibrating bodies includes high-density metal.

12. The disk drive according to claim 11, wherein each of the anti-vibrating bodies includes tungsten alloy.
